(19) United States
(12) Patent Application Publication
(10) Pub. No.: US 2016/0203731 A1
(43) Pub. Date: Jul. 14, 2016

(54) Electronic Educational Assembly

(71) Applicants: Pete T. Kalamaras, Apache Junction, AZ (US); Christine Kalamaras, Apache Junction, AZ (US)

(72) Inventors: Pete T. Kalamaras, Apache Junction, AZ (US); Christine Kalamaras, Apache Junction, AZ (US)

(21) Appl. No.: 14/592,897

(22) Filed: Jan. 8, 2015

(51) Int. Cl. G09B 19/04; G09B 5/04

(52) U.S. Cl. CPC G09B 19/04; G09B 5/04

(57) ABSTRACT

A electronic educational assembly for teaching a child to utilize appropriate social speech patterns includes a housing that has an exterior wall. A processor is coupled to the housing. An electronic memory is coupled to the housing. The electronic memory is operationally coupled to the processor. The electronic memory stores data. The data comprise a plurality of audible words. A speaker is coupled to the housing. The speaker is operationally coupled to the processor. The speaker emits the audible words. At least one actuator is coupled to the housing. The at least one actuator is operationally coupled to the processor. The speaker emits a selected one of the plurality of audible words stored in the electronic memory when the at least one actuator is actuated.

### BACKGROUND OF THE DISCLOSURE

### Field of the Disclosure

The disclosure relates to educational devices and more particularly pertains to a new educational device for teaching a child to utilize appropriate social speech patterns.

### SUMMARY OF THE DISCLOSURE

An embodiment of the disclosure meets the needs presented above by generally comprising a housing that has an exterior wall. A processor is coupled to the housing. An electronic memory is coupled to the housing. The electronic memory is operationally coupled to the processor. The electronic memory stores data. The data comprise a plurality of audible words. A speaker is coupled to the housing. The speaker is operationally coupled to the processor. The speaker emits the audible words. At least one actuator is coupled to the housing. The at least one actuator is operationally coupled to the processor. The speaker emits a selected one of the plurality of audible words stored in the electronic memory when the at least one actuator is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a electronic educational assembly according to an embodiment of the disclosure.

FIG. 2 is a left side view of an embodiment of the disclosure.

FIG. 3 is a front view of an embodiment of the disclosure.

FIG. 4 is a back view of an embodiment of the disclosure.

FIG. 5 is a schematic view of an embodiment of the disclosure.

### DESCRIPTION OF THE PREFERRED EMBODIMENT

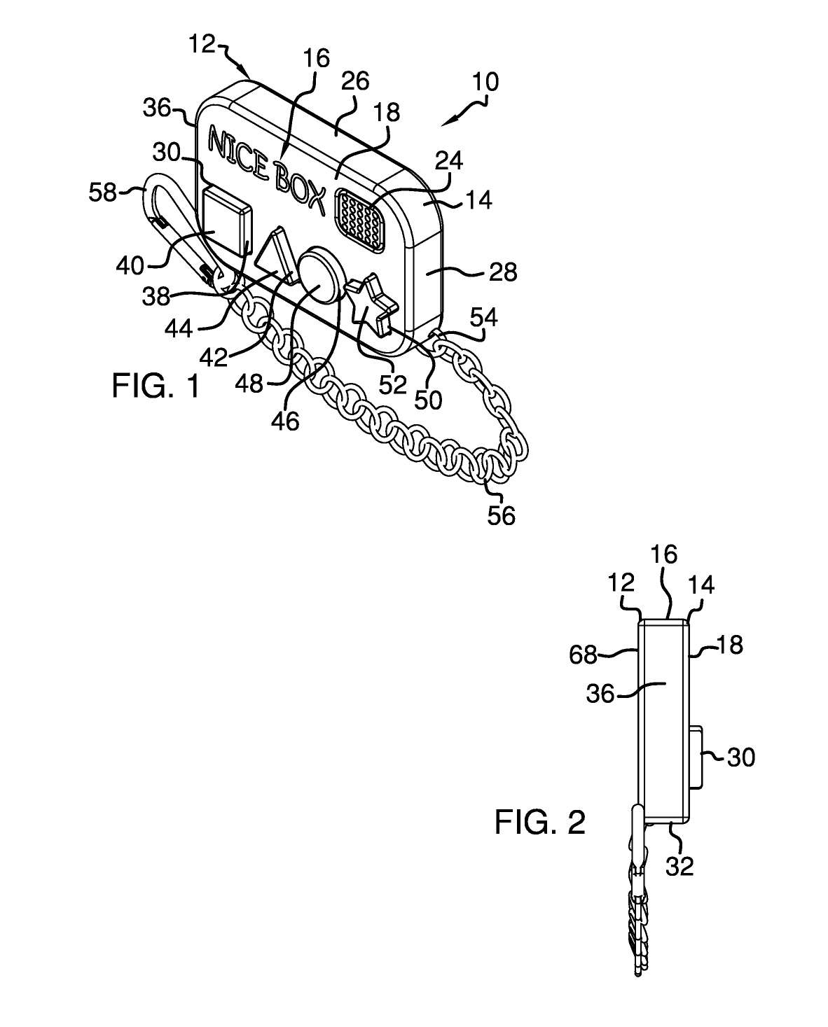

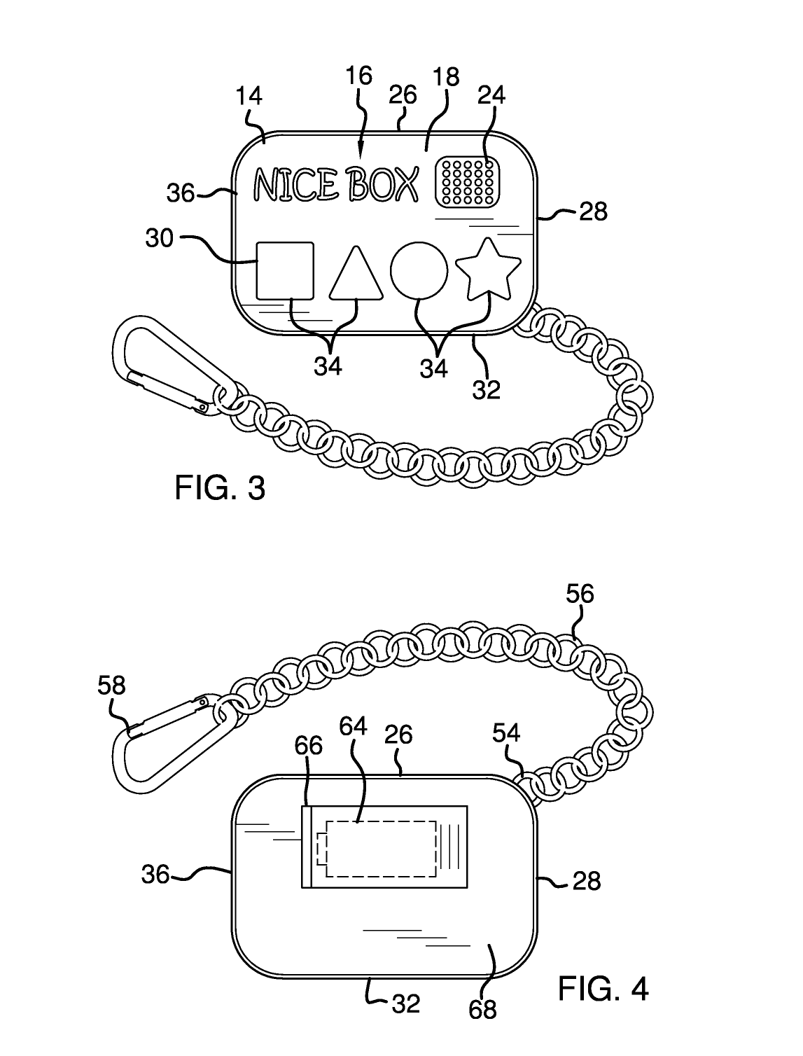

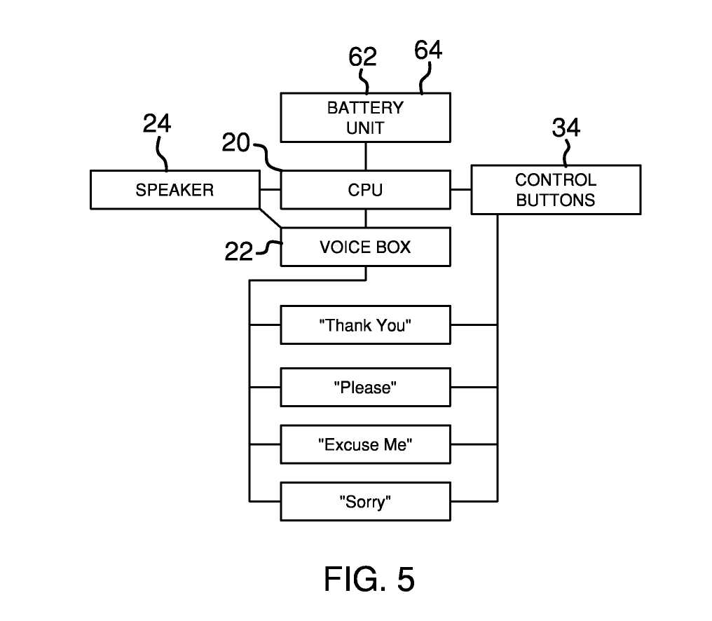

With reference now to the drawings, and in particular to FIGS. 1 through 5 thereof, a new educational device embodying the principles and concepts of an embodiment of the disclosure and generally designated by the reference numeral 10 will be described.

As best illustrated in FIGS. 1 through 5, the electronic educational assembly 10 generally comprises a housing 12 that has an exterior wall 14. The exterior wall 14 of the housing 12 has a width that is greater than a height of the exterior wall 14 of the housing 12. The housing 12 has a rectangular parallelepiped shape. Indicia 16 is printed on a front side 18 of the exterior wall 14 of the housing 12. The indicia 16 may comprise the words “NICE BOX”.

A processor 20 is coupled to the housing 12. The processor 20 may be an electronic processor of any conventional design. An electronic memory 22 is coupled to the housing 12. The electronic memory 22 is electrically coupled to the processor 20. The electronic memory 22 stores data. The electronic memory 22 may be ROM memory of any conventional design. The data comprises a plurality of audible words. The plurality of audible words may comprise the words “Please”, “Thank You”, “Sorry”, and “Excuse Me”.

A speaker 24 is coupled to the front side 18 of the exterior wall 14 of the housing 12. The speaker 24 is positioned proximate an intersection of a top side 26 and a first lateral side 28 of the exterior wall 14 of the housing 12. The speaker 24 is electrically coupled to the processor 20. Moreover, the speaker 24 emits the audible words.

At least one actuator 30 is coupled to the front side 18 of the exterior wall 14 of the housing 12. The at least one actuator 30 is positioned proximate a bottom side 32 of the exterior wall 14 of the housing 12. The at least one actuator 30 is electrically coupled to the processor 20. Additionally, the at least one actuator 30 is one of a plurality of the actuators 34.

The plurality of actuators 34 is evenly spaced apart and distributed between the first lateral side 28 and a second lateral side 36 of the exterior wall 14 of the housing 12. An outer edge 38 of a first one of the plurality of actuators 40 may define a square shape. An exterior edge 42 of a second one of the plurality of actuators 44 may define a triangular shape. An outside edge 46 of a third one of the plurality of actuators 48 may define a circular shape. Finally, an outermost edge 50 of a fourth one of the plurality of actuators 52 may define a star shape.

The speaker 24 emits a selected one of the plurality of audible words stored in the electronic memory 22 when an associated one of the plurality of actuators 34 is actuated. The speaker 24 emits the word “Please” when the first actuator 40 is actuated. The speaker 24 emits the word “Thank You” when the second actuator 44 is actuated. Continuing, the speaker 24 emits the word “Sorry” when the third actuator 48 is actuated. The speaker 24 emits the word “Excuse Me” when the fourth actuator 52 is actuated.

A coupled end 54 of a chain 56 is coupled to an intersection of the bottom side 32 and the first lateral side 28 of the exterior wall 14 of the housing 12. The chain 56 extends away from the housing 12. A clip 58 is coupled to a free end 60 of the chain 56. The clip 58 may selectively engage a user so the housing 12 is retained on the user. The user may be a child.

A power supply 62 is coupled to the housing 12. The power supply 62 is electrically coupled to the processor 20. The power supply 62 comprises at least one battery 64. A battery cover 66 is removably coupled to a back side 68 of the exterior wall 14 of the housing 12. The power supply 62 is positioned beneath the battery cover 66.

In use, a selected one of the first 40, second 44, third 48 or fourth 52 actuators are actuated so an appropriate one of the audible words is emitted from the speaker 24. The selected one of the first 40, second 44, third 48 or fourth 52 actuators are actuated to demonstrate to the child when it is appropriate to utter the associated one of the plurality of audible words. The child learns through repetition when it is appropriate to utter the associated one of the plurality of audible words. Additionally, the audible words are audible to an observer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. An electronic educational assembly for teaching a child to utilize appropriate social speech patterns, said assembly comprising:
a housing having an exterior wall;
a processor coupled to said housing;
an electronic memory coupled to said housing, said electronic memory being operationally coupled to said processor, said electronic memory storing data, said data comprising a plurality of audible words;
a speaker coupled to said housing, said speaker being operationally coupled to said processor wherein said speaker emits the audible words; and
at least one actuator coupled to said housing, said at least one actuator being operationally coupled to said processor, said speaker emitting a selected one of said plurality of audible words stored in said electronic memory when said at least one actuator is actuated.

2. The assembly according to claim 1, wherein said electronic memory being electrically coupled to said processor.

3. The assembly according to claim 1, wherein said speaker being coupled to a front side of said exterior wall of said housing proximate an intersection of a top side and a first lateral side of said exterior wall of said housing.

4. The assembly according to claim 1, wherein said speaker being electrically coupled to said processor.

5. The assembly according to claim 1, wherein said at least one actuator being coupled to a front side of said exterior wall of said housing.

6. The assembly according to claim 1, wherein said at least one actuator being positioned proximate a bottom side of said exterior wall of said housing.

7. The assembly according to claim 1, wherein said at least one actuator being electrically coupled to said processor.

8. The assembly according to claim 1, wherein said at least one actuator being one of a plurality of said actuators.

9. The assembly according to claim 8, wherein said plurality of actuators being evenly spaced apart and distributed between a first lateral side and a second lateral side of said exterior wall of said housing.

10. The assembly according to claim 1, wherein a power supply coupled to said housing.

11. The assembly according to claim 10, wherein said power supply being electrically coupled to said processor.

12. The assembly according to claim 11, wherein said power supply comprising at least one battery.

13. An electronic educational assembly for teaching a child to utilize appropriate social speech patterns, said assembly comprising:
a housing having an exterior wall;
a processor coupled to said housing;
an electronic memory coupled to said housing, said electronic memory being electrically coupled to said processor, said electronic memory storing data, said data comprising a plurality of audible words;
a speaker coupled to a front side of said exterior wall of said housing proximate an intersection of a top side and a first lateral side of said exterior wall of said housing, said speaker being electrically coupled to said processor wherein said speaker emits the audible words;
at least one actuator coupled to said front side of said exterior wall of said housing, said at least one actuator being positioned proximate a bottom side of said exterior wall of said housing, said at least one actuator being electrically coupled to said processor;
said at least one actuator being one of a plurality of said actuators, said plurality of actuators being evenly spaced apart and distributed between said first lateral side and a second lateral side of said exterior wall of said housing;
said speaker emitting a selected one of said plurality of audible words stored in said electronic memory when an associated one of said plurality of actuators is actuated; and
a power supply coupled to said housing, said power supply being electrically coupled to said processor, said power supply comprising at least one battery.
